(19) United States
(12) Patent Application Publication
(10) Pub. No.: US 2026/0038265 A1
(43) Pub. Date: Feb. 5, 2026

(54) SYSTEMS AND METHODS FOR UTILIZING A MULTI-MODAL NEURAL ARCHITECTURE FOR DETECTION AND CLASSIFICATION OF DRIVING EVENTS

(71) Applicant: Verizon Patent and Licensing Inc., Basking Ridge, NJ (US)

(72) Inventors: Leonardo SARTI, Florence (IT); Tommaso BIANCONCINI, Florence (IT); Leonardo TACCARI, Florence (IT); Aurel PJETRI, Firenze (IT)

(73) Assignee: Verizon Patent and Licensing Inc., Basking Ridge, NJ (US)

(21) Appl. No.: 18/790,583

(22) Filed: Jul. 31, 2024

(51) Int. Cl. G06V 20/40; G06V 10/62; G06V 10/774; G06V 10/82; G06V 20/58; G08G 1/01; G09B 19/16

(52) U.S. Cl. CPC G06V 20/44; G06V 10/62; G06V 10/774; G06V 10/82; G06V 20/41; G06V 20/46; G06V 20/58; G08G 1/0141; G09B 19/167

(57) ABSTRACT

A device may receive video data associated with a vehicle experiencing an event, and may utilize an object detection model and an object tracking model to determine object data identifying bounding boxes, tracks, and classes for objects depicted in the video data. The device may process the object data, with an object backbone of a spatiotemporal multi-modal (ST-MM) neural network model, to determine object features associated with dynamics of the objects depicted in the video data, and may determine vehicle features associated with dynamics of the vehicle. The device may process the object features and the vehicle features, with a recurrent neural network of the ST-MM neural network model, to classify the event into a category, and may perform one or more actions based on the category of the event.

### BACKGROUND

Provision of dashcams in vehicles has become increasingly common, with both enterprise fleets and private vehicle owners using these cameras to record driving footage. Dashcam systems often include both forward or front facing cameras (FFCs) capturing a road ahead of a vehicle and driver facing cameras (DFCs) capturing a cabin of the vehicle.

### BRIEF DESCRIPTION OF THE DRAWINGS

FIGS. 1A-1G are diagrams of an example associated with utilizing a multi-modal neural architecture for detection and classification of driving events.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing a multi-modal neural architecture for detection and classification of driving events.

### DETAILED DESCRIPTION OF EXAMPLE EMBODIMENTS

The following detailed description of example implementations refers to the accompanying drawings. The same reference numbers in different drawings may identify the same or similar elements.

In the realm of road safety and transportation, the task of discerning and classifying dangerous driving events from data collected by vehicle sensors is a challenge. Fleet management systems may receive, from connected vehicles, large quantities of data identifying safety-critical driving events (e.g., crash events or near-crash events) and non-critical driving events (e.g., normal events). However, the non-critical driving events vastly outnumbered the safety-critical driving events. Thus, identifying the safety-critical driving events from a deluge of ordinary driving data is a formidable task. For real-time advanced driving assistance systems (ADAS), the swift and accurate detection of events, such as crashes or near-crashes, is vitally important for driver feedback and emergency services. Moreover, in autonomous vehicles, analyzing these events is crucial for identifying operational deficiencies and enhancing vehicle reliability and safety.

Current techniques for classifying driving events associated with vehicles often rely on a fusion of video data (e.g., from vehicle cameras) and vehicle sensor data to create a vector of features. However, the vector of features fails to properly classify driving events for the vast and varied nature of real-world driving scenarios. Thus, current techniques for classifying driving events based on vehicle videos consume computing resources (e.g., processing resources, memory resources, communication resources, and/or the like), networking resources, and/or other resources associated with failing to accurately classify driving events based on vehicle videos, utilizing the inaccurately classified driving events to generate improper driver feedback and/or false alarms for emergency services, failing to identify poor drivers based on failing the accurately classify driving events, and/or the like.

Some implementations described herein provide a video system that utilizes a multi-modal neural architecture for detection and classification of driving events. For example, the video system may receive video data associated with a vehicle experiencing an event, and may utilize an object detection model and an object tracking model to determine object data identifying bounding boxes, tracks, and classes for objects depicted in the video data. The video system may process the object data (e.g., with an object backbone of a spatiotemporal multi-modal (ST-MM) neural network model) to determine object features associated with dynamics of the objects depicted in the video data, and may determine vehicle features associated with dynamics of the vehicle. The video system may process the object features and the vehicle features (e.g., with a recurrent neural network (RNN) of the ST-MM neural network model) to classify the event into a category, and may perform one or more actions based on the category of the event.

In this way, the video system utilizes a multi-modal neural architecture for detection and classification of driving events. For example, the video system may utilize an object detection and an object tracking model to determine object data identifying bounding boxes, tracks, and classes for objects depicted in video data, and may process the object data through an object backbone to determine object features associated with the dynamics of the objects in the video. The video system may process vehicle sensor data (e.g., speed, acceleration, and angular velocity), with a sensor backbone, to determine vehicle features associated with vehicle dynamics. Alternatively, the video system may utilize an ego-motion module to process the video data directly to ascertain the vehicle features. The video system may integrate and analyze the object features and the vehicle features with a recurrent neural network to classify a vehicle event into a category, such as a normal event, a near-crash event, or a crash event.

Thus, the video system may conserve computing resources, networking resources, and/or other resources that would have otherwise been consumed by failing to accurately classify driving events based on vehicle videos, utilizing the inaccurately classified driving events to generate improper driver feedback and/or false alarms for emergency services, failing to identify poor drivers based on failing the accurately classify driving events, and/or the like. By deploying a combination of recurrent and convolutional neural networks, the video system may enhance real-time analysis of complex multimodal data streams, thereby enabling prompt and precise detection and classification of driving events. This may be critical in applications, such as ADAS and autonomous vehicles, where swift processing capabilities can lead to timely interventions and potentially prevent accidents. By intelligently distinguishing between normal and exceptional driving events, the video system may prevent utilization of resources for processing non-critical information and may optimize memory usage across varied vehicle models and environmental settings.

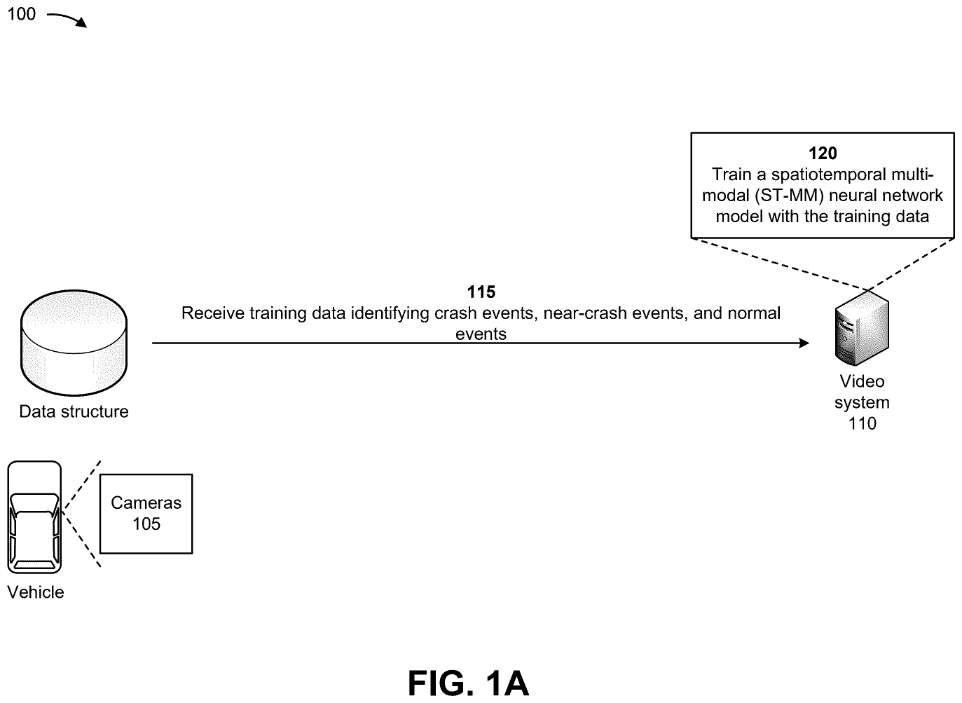

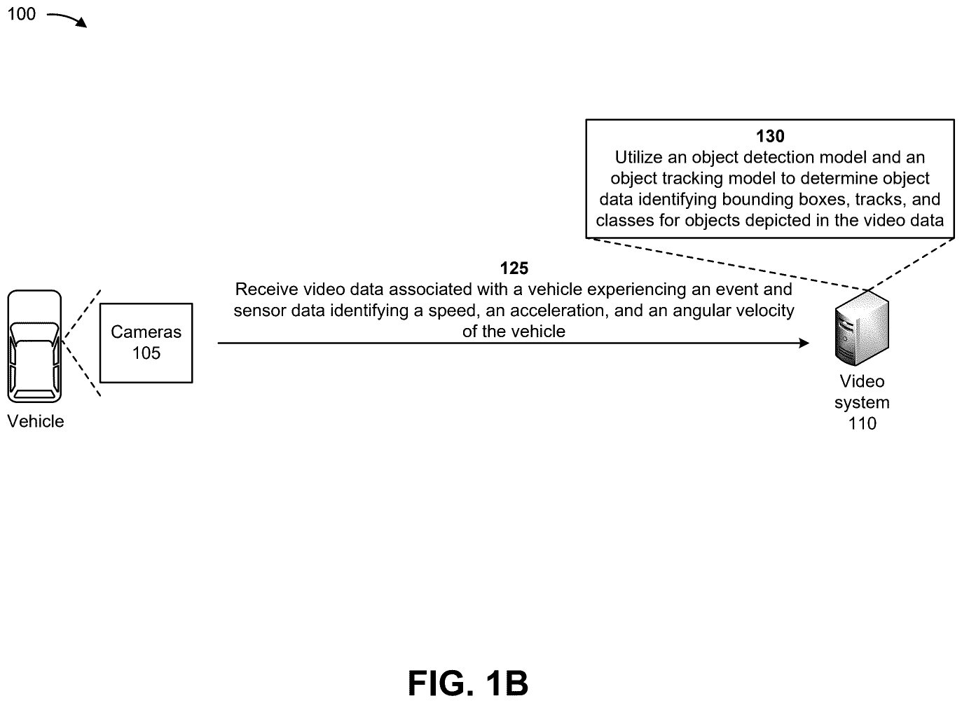

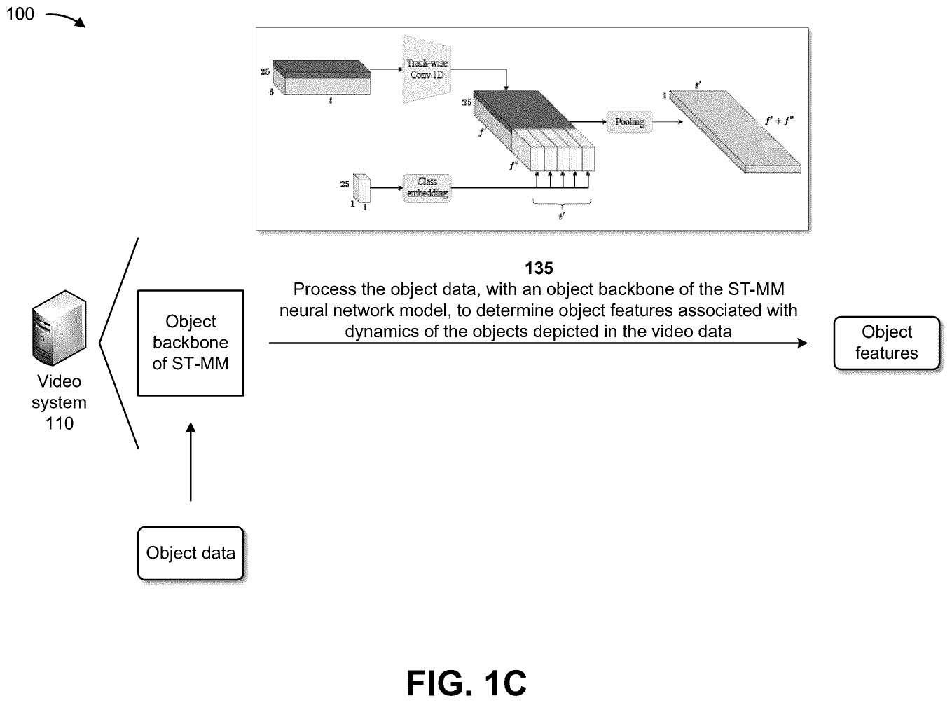

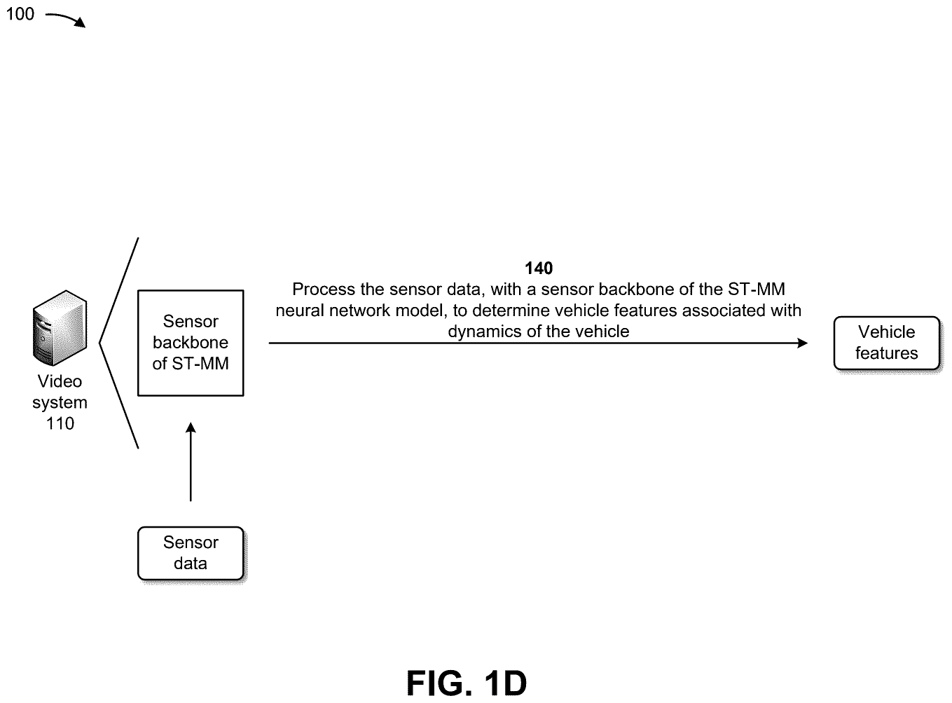

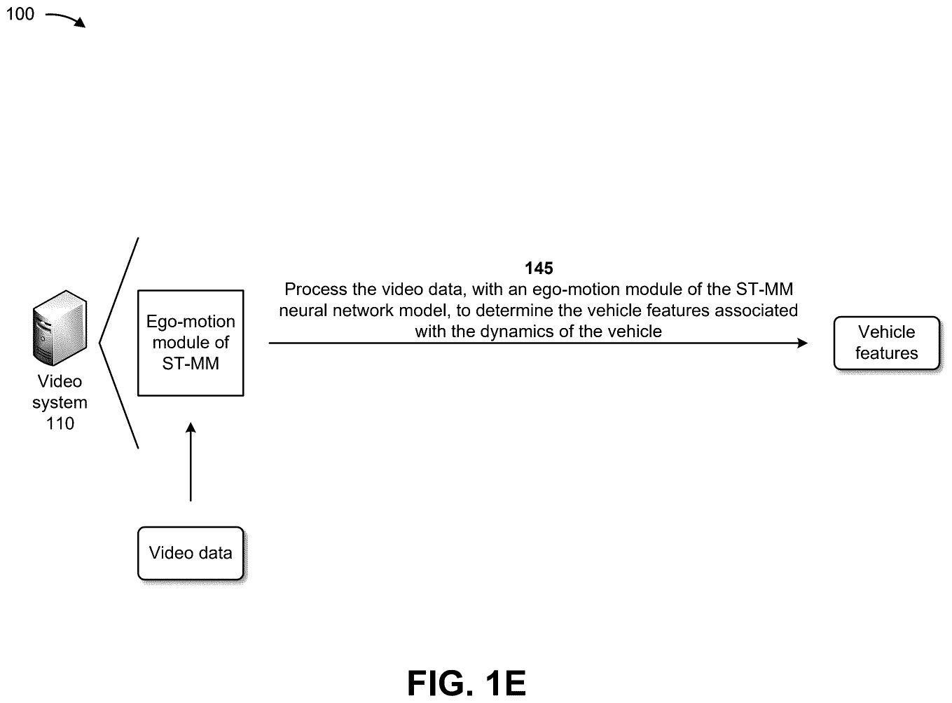

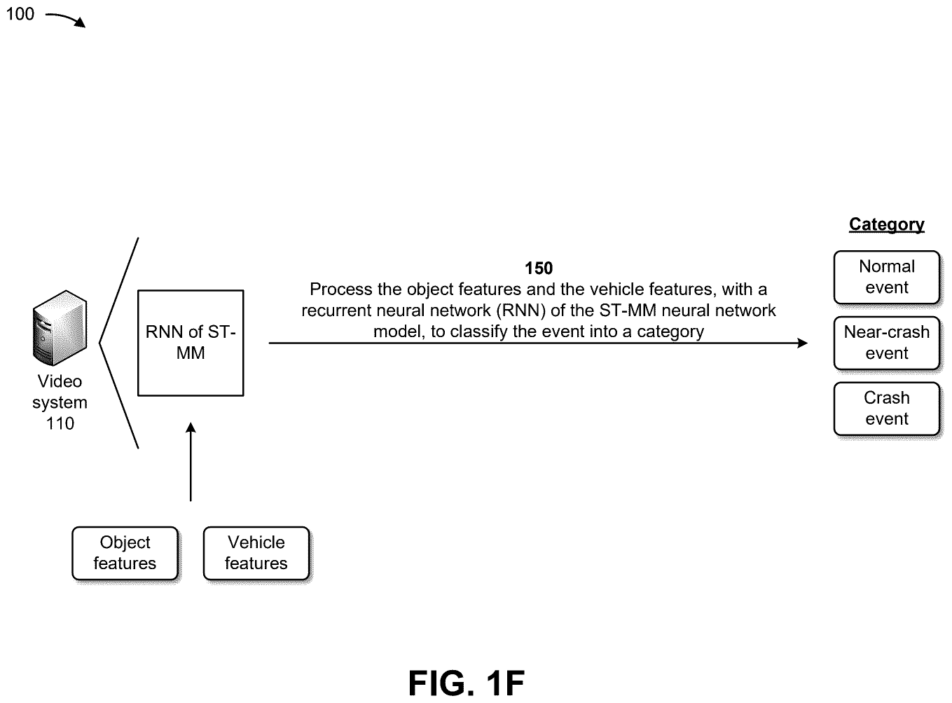

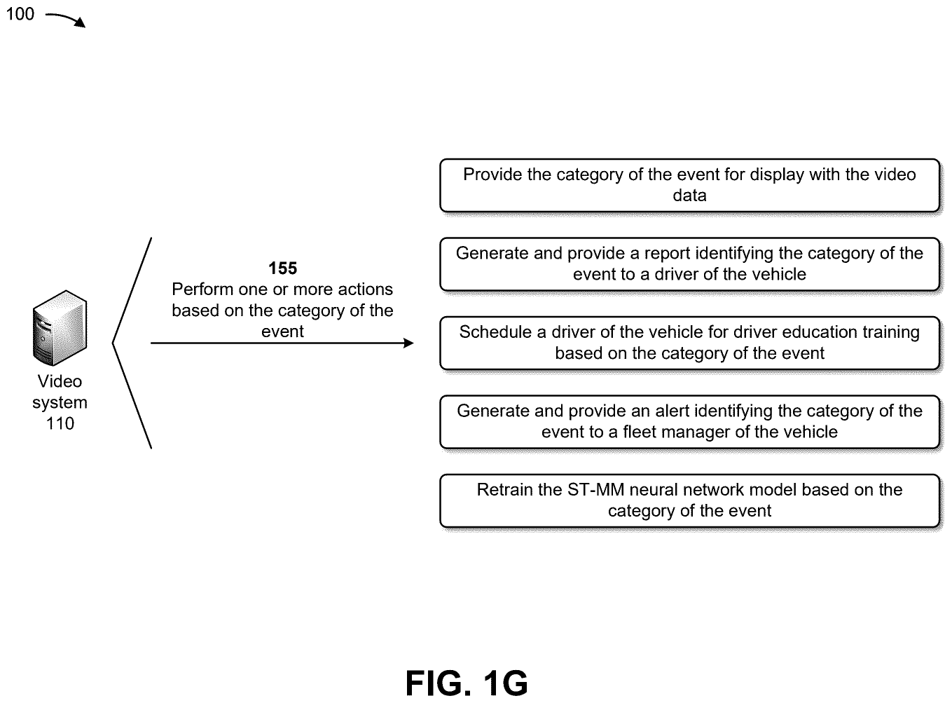

FIGS. 1A-1G are diagrams of an example 100 associated with utilizing a multi-modal neural architecture for detection and classification of driving events. As shown in FIGS. 1A-1G, example 100 includes cameras 105 and a data structure associated with a vehicle and a video system 110. The cameras 105 may capture video of objects (e.g., pedestrians, traffic signs, traffic signals, road markers, a driver, animals, and/or the like) associated with the vehicle. The cameras 105 may include a dashcam of the vehicle, a forward-facing camera of the vehicle, a driver-facing camera of the vehicle, a side camera of the vehicle, a rear camera of the vehicle, and/or the like. The data structure may include a database, a table, a list, and/or the like that stores training data. The video system 110 may include a system that receives and processes video data generated by the cameras 105 and sensor data generated by the vehicle. Further details of the cameras 105, the data structure, the vehicle, and the video system 110 are provided elsewhere herein. Although implementations described herein depict a single vehicle, in some implementations, the video system 110 may be associated with multiple vehicles.

As shown by FIG. 1A, and by reference number 115, the video system 110 may receive training data identifying crash events, near-crash events, and normal events. For example, the video system 110 may be associated with an ST-MM neural network model that includes an object backbone for determining object features associated with dynamics of objects in vehicle video data, an RNN layer, and a classification head. The ST-MM neural network model may include a sensor backbone to determine vehicle features associated with vehicle dynamics based on vehicle sensor data or an ego-motion module that processes the video data directly to ascertain the vehicle features. The RNN layer and the classification head may process the object features and the vehicle features to classify a vehicle event into a category, such as a normal event, a near-crash event, or a crash event. In some implementations, the video system 110 other than the ST-MM neural network model, such as a convolutional long short-term memory (LSTM) model, a transformer model, a spatiotemporal graph convolutional network (ST-GCN) model, a spatiotemporal attention network (STAN) model, a convolutional three-dimensional network model, a multimodal variational autoencoder model, a temporal segment network (TSN) model, and/or the like.

The video system 110 may be associated with a data structure that stores the training data identifying the crash events, the near-crash events, and the normal events. The video system 110 may receive the training data from the data structure based on requesting the training data from the data structure. In some implementations, the training data may include an ego-centric driving dataset with a first quantity of crash events, a second quantity of near-crash events, and a third quantity of normal events. The first quantity, the second quantity, and the third quantity may be added together to form a total quantity of events. The third quantity may account for approximately 85% of the total quantity, the second quantity may account for approximately 14% of the total quantity, and the first quantity may account for approximately 1% of the total quantity. Each event may include a portion (e.g., in seconds) of video data collected from dashcams installed in vehicles. Each event may be triggered by an accelerometer event, such as a backward acceleration event (e.g., braking) event, a forward acceleration event, or a lateral acceleration (e.g., turning) event, and/or the like. The training data may include sensor signals (e.g., global positioning system (GPS) and inertial measurement unit (IMU) signals) and the objects detected and tracked in the video frames. Each event may be labeled as belonging to one of a crash event, a near-crash event, or a normal event. The events of the training data may be split into three sets (e.g., a training set, a validation set, and a test set). The distribution of the training data may be significantly skewed towards normal events (e.g., crash events are roughly one in one hundred).

As further shown in FIG. 1A, and by reference number 120, the video system 110 may train the ST-MM neural network model with the training data. For example, the video system 110 may process the training data to enable improved detection and classification of driving events by the ST-MM neural network model. The training data may form a basis upon which subsequent modeling and categorization of driving events occur. An iterative training process for training the ST-MM neural network model may include the video system 110 providing the ST-MM neural network model with labeled instances of driving events (e.g., the training data) to enable the ST-MM neural network model to effectively learn and distinguish between different categories of driving events. The training process may refine performance of the ST-MM neural network model in accurately classifying and responding to driving events, whether the driving events be normal events, near-crash events, or crash events.

As shown in FIG. 1B, and by reference number 125, the video system 110 may receive video data associated with a vehicle experiencing an event and sensor data identifying a speed, an acceleration, and an angular velocity of the vehicle. For example, one or more of the cameras 105 associated with the vehicle may continuously capture the video data associated with the vehicle experiencing the event. The vehicle may also be associated with a GPS sensor that captures the speed of the vehicle experiencing the event, and an IMU sensor that captures the acceleration and the angular velocity of the vehicle experiencing the event. The signals captured by the GPS sensor and the IMU sensor may correspond to the sensor data identifying the speed, the acceleration, and the angular velocity of the vehicle. In some implementations, the video system 110 may periodically receive the video data associated with the vehicle experiencing the event and the sensor data identifying the speed, the acceleration, and the angular velocity of the vehicle, may continuously receive the video data and the sensor data, may receive the video data and the sensor data based on requesting the video data and the sensor data from the vehicle, and/or the like.

The video system 110 may receive the video data from the cameras 105 mounted on and/or in the vehicle, and may receive the sensor data from the sensors mounted on the vehicle. The video data may provide visual context and the sensor data may provide quantitative measurements regarding dynamics of the vehicle during the event. The sensor data may enable the video system 110 to assess maneuvers of the vehicle and possible driving events (e.g., harsh braking or rapid acceleration) which may be indicative of near-crash or crash scenarios. The incorporation of the sensor data allows for a more nuanced analysis by providing additional dimensions to contextual information gathered from the video data alone. This multimodal approach enhances the overall capability of the video system 110 to detect and categorize driving events with greater accuracy.

In some implementations, the video system 110 may receive the video data from multiple dashcams installed in various positions within the vehicle to provide multiple perspectives of the event. This enhances an ability of the video system 110 to understand the event from all angles, offering a more detailed and comprehensive analysis. Additionally, or alternatively, the video data may be generated by exterior cameras mounted on the vehicle to capture surrounding traffic conditions. This alternative is particularly useful for assessing the vehicle's interaction with an environment, capturing events, such as near-miss incidents or minor collisions, that may not be as clearly depicted by internal cameras. Additionally, or alternatively, the video data may also include thermal imaging to capture more detail in low-visibility conditions. Thermal imaging can be beneficial in foggy, smoky, or nighttime scenarios, where standard cameras might miss crucial information.

In some implementations, the sensor data may include additional parameters beyond speed, acceleration, and angular velocity, such as tire traction levels, steering angle, and brake pressure. Including these parameters may provide the video system 110 with a more nuanced understanding of the vehicle's state and how the driver is interacting with the vehicle controls during the event. Additionally, or alternatively, the sensor data may be coupled with environmental data, such as weather conditions from external weather services, which may influence vehicle dynamics. Environmental data may often play a critical role in vehicular events, and accounting for environmental data may significantly improve the analysis accuracy. Additionally, or alternatively, additional data could be obtained not only from onboard vehicle diagnostics, but also from connected infrastructure like smart traffic systems for a broader understanding of the event. Utilizing connected infrastructure data may provide contextual information that may otherwise be unavailable, such as a state of nearby traffic lights or congestion levels, which could influence the vehicle behavior and the event outcome.

In some implementations, the video system 110 may preprocess the video data to highlight or annotate safety-critical events within the video data before further analysis. Preprocessing the video data may facilitate quicker identification of critical moments, aiding in rapid response and detailed event investigation. Additionally, or alternatively, the video system 110 may apply noise reduction models to the sensor data to filter out irrelevant fluctuations and improve event classification accuracy. Noise reduction may isolate significant data markers from the noise of regular or expected sensor readings, thereby refining the event analysis. In some implementations, the video system 110 may augment the video data and/or the sensor data with historical data from similar vehicles or events to enhance predictive capabilities of the ST-MM neural network model. The historical data may enable the ST-MM neural network model to recognize patterns and traits it might otherwise miss and may improve learning and predictive accuracy of the ST-MM neural network model.

As further shown in FIG. 1B, and by reference number 130, the video system 110 may utilize an object detection model and an object tracking model to determine object data identifying bounding boxes, tracks, and classes for objects depicted in the video data. For example, object detection is a popular approach as a first step in a video analysis pipeline, since an object detection model enables determination of information about what appears in a video segment and where each entity is located in the video segment. Furthermore, an object tracking model may link together bounding boxes associated with the same entity in different frames across the video data, and may generate a full semantic description of the evolution of the entity in the video data. In this way, at any point in time, the object tracking model may provide a position, a velocity, and a distance from a camera 105 (e.g., approximated through the bounding box size) of every object. For example, the video system 110 may receive and process the video data to detect and track various objects, categorizing the objects with appropriate classes, such as person, animal, vehicle, and/or the like, based on characteristics of the objects. This may enable the video system 110 to create an organized dataset, laying the groundwork for subsequent analysis steps, such as identifying potential graphic content and facilitating the efficient extraction of relevant information from the video data.

In some implementations, the object data may include additional features or details based on other sensors or inputs, such as telematics sensor data that provides contextual dynamics of the vehicle during the event. For example, if telematics data indicates a sudden stop or a sharp change in vehicle direction, the video system 110 can prioritize analyzing frames around this time period, presuming a higher likelihood of capturing an event of interest. In some implementations, one or more of the cameras 105 may include the object detection model and the object tracking model, and may utilize the object detection model and the object tracking model to determine the object data identifying the bounding boxes, the tracks, and the classes (e.g., person, car, truck, and/or the like) for the objects depicted in the video data. The determination of the object data provides a comprehensive and automated initial assessment of the event, which aids in focusing on potentially significant occurrences that warrant further examination.

In some implementations, the video system 110 may preprocess the video data (e.g., raw video frames) to extract object tracks for an object backbone of the ST-MM neural network model. The object detection model may be based on a you only look once (YOLO) architecture. The YOLO model may be pretrained with a common objects in context (COCO) dataset that significantly improves the accuracy of the original YOLO model. The pretrained YOLO model may be fine-tuned with a dataset that focuses on particular road object classes (e.g., a person, a bicycle, a car, a motorcycle, a bus, a truck, a traffic light, a stop sign, an animal, a yield sign, a speed limit sign, and/or the like). The object detection model may be executed for each frame, so a position and a class of each object may be extracted. A non-maximal suppression model that works at a macro-category level (e.g., where a truck and a car belong to the same vehicle macro-category) may be utilized to prevent mistakes in ambiguous cases (e.g., large pickups).

The object tracking model may be executed for each separate macro-category to avoid merging objects belonging to different classes. The object tracking model may include a simple online and real time tracker (SORT) model that is efficient and works well with high-frequency and large objects. The object detection model and the object tracking model may generate object data that includes a set of object tracks, with a location vector (e.g., top-left corner coordinates and a bounding box's width and height), a detection confidence, and a class for each frame of the video data.

In some implementations, the video system 110 may utilize computer vision techniques, such as semantic segmentation models, to determine the object data. Semantic segmentation models differentiate various parts of an image at a pixel level, provide a more nuanced delineation of objects within a frame, and may be utilized for complex scenes where objects are closely intertwined or overlapping. Additionally, or alternatively, the video system 110 may utilize machine learning models other than object detection and tracking models, such as support vector machines or neural networks that specialize in image recognition tasks. These alternative models may enhance the ability of the video system 110 to classify objects within the video data, potentially offering improved accuracy or efficiency over traditional detection and tracking methods.

Additionally, or alternatively, the video system may enrich object classes with a broader range of classifications, including but not limited to makes and models of vehicles, pedestrian actions, specific types of traffic infrastructures, and/or the like. The enriched classifications may provide additional context and detail, which may enhance an understanding of the observed scene and may support more comprehensive data analysis by the video system 110. Additionally, the video system 110 may utilize an anomaly detection model to identify unusual object behavior or unexpected static objects, thereby improving event categorization and response. Anomaly detection models may reveal critical insights into abnormalities that may indicate potential hazards or security concerns. Additionally, or alternatively, for object tracking, the video system 110 may prioritize the tracking of objects based on proximity of the objects to the vehicle or a significance of the objects in the driving context. By focusing on the most influential objects, the video system 110 may optimize resource allocation and improve the relevance of the tracking data.

Additionally, or alternatively, edge computing devices may be utilized to perform initial object data processing directly within the vehicle before sending the object data to the video system 110 for more detailed processing and analysis. By utilizing edge computing devices, latency and bandwidth usage may be reduced, providing quicker response times for critical applications. In some implementations, the object tracking model may incorporate predictive modeling to anticipate future positions of objects based on detected tracks, thereby aiding in the assessment of potential collision paths. Predictive modeling may add a proactive aspect, enabling the video system 110 to foresee possible developments in a scene and act accordingly.

As shown in FIG. 1C, and by reference number 135, the video system 110 may process the object data, with an object backbone of the ST-MM neural network model, to determine object features associated with dynamics of the objects depicted in the video data. For example, the ST-MM neural network model may include an object backbone for processing the object data. The object backbone may utilize a sequence of one-dimensional convolutional layers to process tracks independently for each object, and to condense and extract the most important information related to the motion of objects around the vehicle. The processing of the object data may generate object features for subsequent event classification. The object backbone may receive a quantity of object tracks obtained from the object detection and tracking models.

The object backbone and other backbones and/or modules utilized by the ST-MM neural network model may be convolutional. Each convolutional block may include a one-dimensional or a two-dimensional convolution followed by a batch normalization layer, an activation function, and a max pooling layer. A convolution kernel stride may be set to a value (e.g., one). The object backbone may down sample hidden representations along a temporal dimension with the max pooling layers and may utilize a stride equal to a kernel size. The object backbone may encode a tensor containing bounding box data through one-dimensional convolutional blocks applied independently to each track. The convolutions and the max pooling may include a kernel size (e.g., of one) along a dimension corresponding to an object. The object backbone may process the road object class of each object with an embedding layer, and may repeat and concatenate the object class embedding to a feature extracted from the bounding box data. An obtained tensor may be provided along an object dimension by means of the max pooling layer.

Additionally, or alternatively, the video system 110 may process the object data with a separate dedicated neural network model tailored specifically for object feature extraction. This specialized model may provide for a more refined analysis of the object features by leveraging architectures specifically designed for parsing detailed object attributes. Moreover, the specialized model may provide computational efficiencies by focusing solely on the extraction of object features without additional overhead of broader network functionalities.

In some implementations, the object backbone may enhance a relevance of the dynamics of each object, which may include movement patterns, relative velocities, and directional changes over consecutive frames. These nuances in object dynamics may be utilized to identify the safety-critical events from the video data. Additionally, or alternatively, the object features determined from the video data may include object trajectory predictions or estimated future positions based on current dynamics. Such forward-looking measures may provide a more proactive stance in event classification, giving the video system 110 insights into possible future developments of the objects in motion, which, in turn, may facilitate better anticipation of potential crash events.

In some implementations, the object backbone may utilize a dimension-reduction technique (e.g., a principal component analysis (PCA)) on the object features to focus on the most significant features of object dynamics. The PCA may simplify the object feature space by reducing the space to principal components to enhance performance of the object backbone in identifying pertinent features linked to dynamics of the event. In some implementations, the object backbone may apply non-maximal suppression to the objects to mitigate incorrect object categorizations which may improve the accuracy of the object feature determination. Additionally, or alternatively, the object backbone may integrate optical flow information that captures motion pattern changes over time. Optical flow integration may provide a more nuanced understanding of object movements, further empowering the video system 110 in discerning subtle shifts in dynamics that may indicate an emergency event. In some implementations, the object backbone may utilize adaptive filtering techniques to ensure the relevance of the object features in changing environmental conditions. Adaptive filtering may adapt to varying lighting conditions, weather changes, and other external factors that possibly affect the visibility and trackability of objects, contributing to a more robust object feature determination process.

As shown in FIG. 1D, and by reference number 140, the video system 110 may process the sensor data, with a sensor backbone of the ST-MM neural network model, to determine vehicle features associated with dynamics of the vehicle. For example, the ST-MM neural network model may include a sensor backbone for processing the sensor data. The sensor backbone may process the sensor data and may progressively generate higher-level features (e.g., the vehicle features) associated with the dynamics of the vehicle. The IMU data, and the acceleration in particular, may be utilized by the sensor backbone to assess a type and a harshness of maneuvers of the vehicle, and may be useful in situations where the event does not involve a visible object in the video data (e.g., a rear collision).

In some implementations, the sensor backbone may align sampling rates of different sensors (e.g., the GPS, the IMU, and/or the like) and the video data timestamps, and may filter the sensor data to extracting high-level vehicle features. In a first stage, the sensor backbone may encode the sensor data separately by a different convolutional branch for each sensor data type (e.g., the speed, the acceleration, and the angular velocity of the vehicle). In a second stage, the sensor backbone may concatenate and process intermediate representations by another sequence of convolutional blocks. The sensor backbone may align a temporal dimension of the vehicle features with a temporal dimension of the object features (e.g., generated by the object backbone) with an adaptive average pooling.

In some implementations, the sensor backbone may utilize one-dimensional convolutional layers to process the speed, the acceleration, and the angular velocity of the vehicle independently. Additionally, or alternatively, the video system 110 may utilize alternative deep learning models, such as multi-dimensional convolutional layers, RNNs, or long short-term memory (LSTM) networks, to process the sensor data and generate the vehicle features. These advanced neural network architectures may capture more complex patterns and dependencies in the sensor data, and may provide a richer characterization of the vehicle's dynamics.

In some implementations, the sensor backbone may synchronize and modify the sensor data to match frequencies across different sensor data types and to ensure accurate and coherent processing of the sensor data. Additionally, or alternatively, the video system 110 may utilize normalization or standardization techniques on the sensor data prior to processing the sensor data with the sensor backbone to ensure consistent scale and distribution of the sensor data. Normalization may include scaling the sensor data to a specific range, such as between zero and one, while standardization may include adjusting the sensor data so that it has a mean of zero and a standard deviation of one, both of which can aid in the comparability and accuracy of the processed data.

Additionally, or alternatively, the video system 110 may utilize convolutional encoding to align the sensor data with the video data and to enhance a correlation between observed events in the video data and the sensed vehicular dynamics in the sensor data. Additionally, or alternatively, the video system 110 may utilize alternative methods of synchronizing the sensor data with the video data, such as resampling techniques or utilization of time stamps to accurately align the sensor data with the video data. These methods may improve temporal alignment between different data sources, which may be crucial for accurate event analysis.

As shown in FIG. 1E, and by reference number 145, the video system 110 may process the video data, with an ego-motion module of the ST-MM neural network model, to determine the vehicle features associated with the dynamics of the vehicle. For example, if the sensor data is not available, the video system 110 may alternatively utilize an ego-motion module of the ST-MM neural network model. The ego-motion module may be pretrained to predict vehicle speed and acceleration from the video data. The ego-motion module may determine the vehicle dynamics based on a correlation of a pair of frames sampled at different points in time.

The ego-motion module may be based on optical flow estimation with end-to-end regressors, where an optical flow between two video frames may depend mostly on vehicle motion. Being able to predict the optical flow on a given pair of video frames may indicate that the vehicle motion has been properly estimated. The ego-motion module may utilize a convolutional encoder to extract appearance features from pairs of consecutive video frames concatenated along a channel axis. To ensure that the ego-motion module specializes in estimating the vehicle motion, at training time, a regression loss may be added for the task of predicting the speed and the acceleration of the vehicle. The regression loss may be added by providing features extracted by the ego-motion module to an additional recurrent layer, that is discarded at inference time (e.g., such that the ego-motion module directly influences the classification of the event without using speed and acceleration as intermediate steps in the classification process). In the training phase, the ego-motion module may be trained to recognize and predict vehicle dynamics based on video data alone. Such training involves using known speed and acceleration data as labels to provide the ego-motion module with the ability to estimate these parameters from the video data in future analyses. In some implementations, the ego-motion module operates on the video data to analyze and infer vehicle motion, such as speed and acceleration, without relying on direct sensor inputs for these parameters.

In some implementations, inferring vehicle dynamics solely from the video data may reduce reliance on vehicle-installed sensors, and may provide a more adaptable and scalable video system 110. This could be particularly advantageous when the sensor data is unavailable or when there is a need to deploy the video system 110 in settings with different sensor configurations or none at all. Furthermore, the ego-motion module, once trained to estimate vehicle dynamics from the video data, may deliver insights into vehicle behavior by examining nuanced changes in a visual field that may not be directly measured by sensors. This capability extends the proficiency of the video system 110 in capturing high-frequency signals that are reflective of safety-critical events, ensuring a robust analysis of driving scenarios.

In some implementations, the ego-motion module may infer other vehicle dynamics, such as a turning rate or lane deviations. This can be achieved by analyzing lane markings or surrounding environmental features within the video data, as opposed to direct sensor measurements. Additionally, or alternatively, the ego-motion module may be enhanced with additional labeled video data indicative of various driving contexts, such as urban or highway. This may aid in improving the predictive capabilities for vehicle dynamics, ensuring that the video system 110 is robust across different driving scenarios.

Additionally, or alternatively, the ego-motion module may predict additional vehicle dynamics parameters, like yaw rate or lateral movement, which provide a more comprehensive understanding of the vehicle's behavior. To predict the additional vehicle dynamics parameters, computer vision techniques such as feature tracking or scene segmentation may be integrated with the ego-motion module, thereby aiding the ego-motion module in estimating vehicle dynamics with greater accuracy. Additionally, or alternatively, the ego-motion module may be provided in driver assistance systems for real-time alerts. This may provide drivers with immediate feedback on their driving patterns inferred from video data, and may encourage safer driving habits. Additionally, or alternatively, adapting the ego-motion module to analyze video data captured from different camera perspectives, including rear or side views, may provide a more comprehensive multi-angle assessment of vehicle dynamics. The use of map data in conjunction with the ego-motion module may be utilized to contextualize the vehicle dynamics in relation to geographic location and typical traffic patterns.

As shown in FIG. 1F, and by reference number 150, the video system 110 may process the object features and the vehicle features, with an RNN of the ST-MM neural network model, to classify the event into a category. For example, the ST-MM neural network model may include an RNN that classifies the event into a category, such as a normal event, a near-crash event, a crash event, and/or the like. The video system 110 may align the object features and the vehicle features to a same temporal frame and may merge the aligned object and vehicle features, so the aligned object and vehicle features may be provided to the RNN. The RNN may extract spatiotemporal information from the aligned object and vehicle features, and may provide the spatiotemporal information to a classification head. The classification head may classify the event into the category.

In some implementations, the video system 110 may concatenate the object features and the vehicle features before being forwarded to the RNN. The RNN may process the concatenated object features and vehicle features to generate a final hidden state. The final hidden state is then processed by a dense layer (e.g., the classification head) to determine a classification (e.g., to classify the event into the category). The RNN may include a bidirectional recurrent module so that features utilized for the classification are obtained by concatenating a last forward hidden representation together with a final backward representation.

In some implementations, the RNN may combine the dynamic features of the objects and the vehicle ascertained through the earlier layers of the ST-MM neural network model, bringing together spatiotemporal data into a cohesive analysis. In some implementations, the video system 110 may utilize a convolutional neural network (CNN) (e.g., in conjunction with or in place of the RNN) to process the combined object and vehicle features for event classification. The CNN may analyze spatial patterns within video frames, capturing object shapes and orientations in addition to temporal trends. This may be beneficial when distinguishing between static and dynamic objects, or analyzing complex trajectories of moving objects.

In some implementations, processing the object features and the vehicle features may include incorporating an attention mechanism into the ST-MM neural network model. The attention mechanism may enable the ST-MM neural network model to dynamically focus on certain areas or features within the video and sensor data that are important for classifying the event, thereby enhancing the accuracy and efficiency of the classification process. For example, if an object suddenly appears close to the vehicle, the attention mechanism could highlight this for the ST-MM neural network model to prioritize in its analysis, potentially indicating an imminent collision and resulting in the classification of the event as a crash event.

Additionally, or alternatively, classifying the event into a category may include employing a transformer-based architecture, extending a bidirectional aspect of the RNN. This advanced architecture may enable the video system 110 to better understand the complex temporal relationships between object and vehicle dynamics by offering a more global viewpoint of the sequences, potentially increasing the accuracy of event classification for both immediate and predictive analysis. In some implementations, the category output by the video system 110 may also include fine-grained subcategories beyond normal, near-crash, or crash events to reflect a wider range of on-road scenarios and driving behaviors. By doing so, the video system 110 could provide more specific information for after-the-fact analyses or real-time interventions, creating opportunities for targeted driver assistance or training interventions, responsive to the exact nature of the event.

As shown in FIG. 1G, and by reference number 155, the video system 110 may perform one or more actions based on the category of the event. In some implementations, performing the one or more actions includes the video system 110 providing the category of the event for display with the video data. For example, the video system 110 may provide the category of the event and the video data to a user device associated with a driver of the vehicle or a fleet manager of the vehicle. The user device may display the category and the video data to the driver and/or the fleet manager. This may provide real-time or post-event visual feedback, which can be crucial for drivers or fleet managers to understand the context and severity of the event. Additionally, or alternatively, the video system 110 may store the category and/or the video data for later analysis or review. This may facilitate long-term trend assessment and proactive safety measures by accumulating and analyzing event data over time to observe patterns and implement preventative strategies. In this way, the video system 110 conserves computing resources, networking resources, and/or other resources that would have otherwise been consumed by failing to accurately classify driving events based on vehicle videos.

In some implementations, performing the one or more actions includes the video system 110 generating and providing a report identifying the category of the event to a driver of the vehicle. For example, the video system 110 may generate and provide a report identifying the category of the event to a driver of the vehicle and/or to a fleet manager of the vehicle. Such a report may serve as a valuable tool for driver feedback and awareness, highlighting areas where driving behavior might need improvement. The report may also include recommendations for corrective actions or safety measures, which may ensure that the driver is not only informed about the event classification but is also provided with actionable guidance to mitigate future risks specific to the event category. In this way, the video system 110 conserves computing resources, networking resources, and/or other resources that would have otherwise been consumed by utilizing the inaccurately classified driving events to generate improper driver feedback.

In some implementations, performing the one or more actions includes the video system 110 scheduling a driver of the vehicle for driver education training based on the category of the event. For example, the video system 110 can schedule a driver of the vehicle for driver education training based on the category of the event. This may emphasize the educational and preventative aspects of the video system 110, using categorized events as a means to enhance driver safety and competence. Additionally, or alternatively, the driver education training may include customized training modules to ensure that the training is directly relevant to identified risk areas, further optimizing the educational intervention for maximum impact and safety improvement. In this way, the video system 110 conserves computing resources, networking resources, and/or other resources that would have otherwise been consumed by failing to identify poor drivers based on failing the accurately classify driving events.

In some implementations, performing the one or more actions includes the video system 110 generating and providing an alert identifying the category of the event to a fleet manager of the vehicle. For example, the video system 110 may generate and provide the alert to a user device of the fleet manager, and the user device may provide the alert to the fleet manager. Such alerts may facilitate fleet management, ensuring that appropriate actions are taken in response to safety-critical events, potentially influencing driver training programs or operational protocols. Additionally, or alternatively, such alerts could be integrated into a broader fleet safety management system. By doing this, the system could trigger automatic workflows or protocols in response to specific event categories, streamlining the response to incidents and bolstering overall fleet safety measures. In this way, the video system 110 conserves computing resources, networking resources, and/or other resources that would have otherwise been consumed by failing to identify poor drivers based on failing the accurately classify driving events.

In some implementations, performing the one or more actions includes the video system 110 retraining the ST-MM neural network model based on the category of the event. For example, the video system 110 may utilize the category of the event as additional training data for retraining the ST-MM neural network model, thereby increasing the quantity of training data available for training the ST-MM neural network model. Accordingly, the video system 110 may conserve computing resources associated with identifying, obtaining, and/or generating historical data for training the ST-MM neural network model relative to other systems for identifying, obtaining, and/or generating historical data for training machine learning models.

In some implementations, performing the one or more actions may include the video system 110 initiating automated vehicle diagnostics or maintenance checks if the event category suggests potential vehicle issues that need attention. This may preemptively address vehicle conditions that may otherwise escalate into safety-critical scenarios if left unattended. Additionally, or alternatively, the video system 110 may communicate and collaborate with external safety monitoring or emergency services. This proactive engagement means that in scenarios such as crash events, emergency response can be accelerated, potentially reducing the impact and severity of such incidents.

In some implementations, the video system 110 may utilize the classified event data to adjust the vehicle's future route planning. By considering the location and context of previous events, the video system 110 may enhance safety by navigating away from areas with higher incidences of problematic events. This may proactively mitigate risk by utilizing historical data to inform future decision-making for route choices. In some implementations, the video system 110 may offer a feedback mechanism that allows drivers or fleet managers to provide their input on the event categorization. Such a mechanism may promote a continuous feedback loop for system accuracy improvement, ensuring that user insights are utilized to refine the event classification process and maintain the reliability of the system. In some implementations, the video system 110 may utilize the classified event data to generate routes and/or driving instructions for an autonomous vehicle or a semi-autonomous vehicle.

In this way, the video system 110 utilizes a multi-modal neural architecture for detection and classification of driving events. For example, the video system 110 may utilize an object detection and an object tracking model to determine object data identifying bounding boxes, tracks, and classes for objects depicted in video data, and may process the object data through an object backbone to determine object features associated with the dynamics of the objects in the video. The video system 110 may process vehicle sensor data (e.g., speed, acceleration, and angular velocity), with a sensor backbone, to determine vehicle features associated with vehicle dynamics. Alternatively, the video system 110 may utilize an ego-motion module to process the video data directly to ascertain the vehicle features. The video system 110 may integrate and analyze the object features and the vehicle features with a recurrent neural network to classify a vehicle event into a category, such as a normal event, a near-crash event, or a crash event.

Thus, the video system 110 may conserve computing resources, networking resources, and/or other resources that would have otherwise been consumed by failing to accurately classify driving events based on vehicle videos, utilizing the inaccurately classified driving events to generate improper driver feedback and/or false alarms for emergency services, failing to identify poor drivers based on failing the accurately classify driving events, and/or the like. By deploying a combination of recurrent and convolutional neural networks, the video system 110 may enhance real-time analysis of complex multimodal data streams, thereby enabling prompt and precise detection and classification of driving events. This may be critical in applications, such as ADAS and autonomous vehicles, where swift processing capabilities can lead to timely interventions and potentially prevent accidents. By intelligently distinguishing between normal and exceptional driving events, the video system 110 may prevent utilization of resources for processing non-critical information and may optimize memory usage across varied vehicle models and environmental settings.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

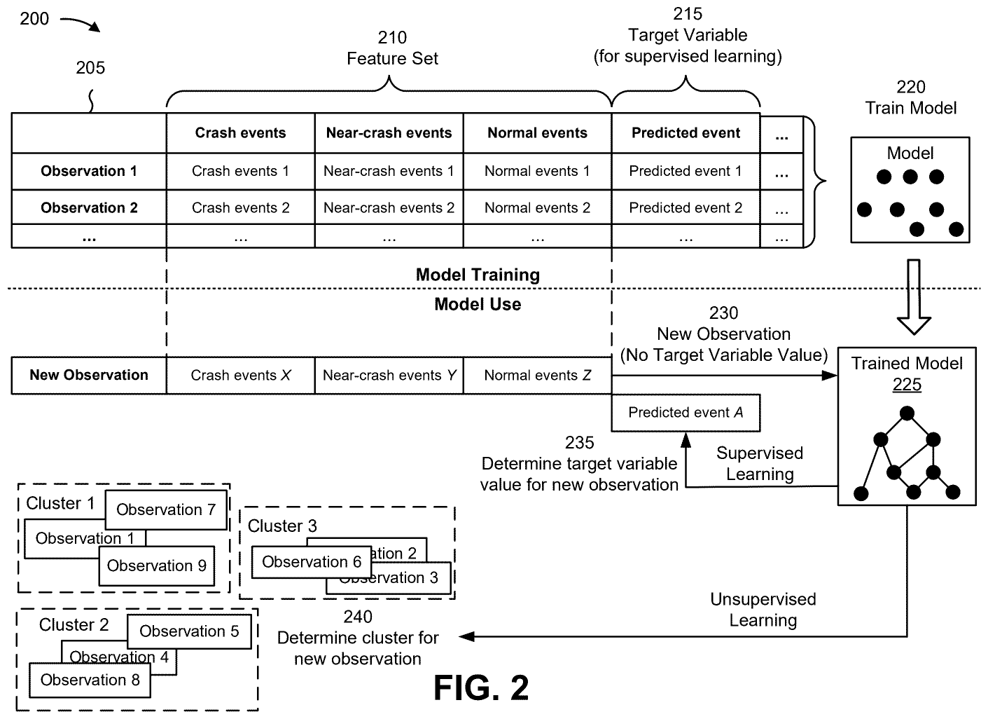

FIG. 2 is a diagram illustrating an example 200 of training and using a machine learning model for detecting and classifying driving events. The machine learning model training and usage described herein may be performed using a machine learning system. The machine learning system may include or may be included in a computing device, a server, a cloud computing environment, and/or the like, such as the video system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the video system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the video system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of crash events, a second feature of near-crash events, a third feature of normal events, and so on. As shown, for a first observation, the first feature may have a value of crash events 1, the second feature may have a value of near-crash events 1, the third feature may have a value of normal events 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “predicted event” and may include a value of predicted event 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of crash events X, a second feature of near-crash events Y, a third feature of normal events Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of predicted event A for the target variable of the predicted event for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a crash events cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a near-crash events cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to detect and classify driving events. The machine learning system enables recognition and/or identification of tens, hundreds, thousands, or millions of features and/or feature values for tens, hundreds, thousands, or millions of observations, thereby increasing accuracy and consistency and reducing delay associated with detecting and classifying driving events relative to requiring computing resources to be allocated for tens, hundreds, or thousands of operators to manually detect and classify driving events.

As indicated above, FIG. 2 is provided as an example. Other examples may differ from what is described in connection with FIG. 2.

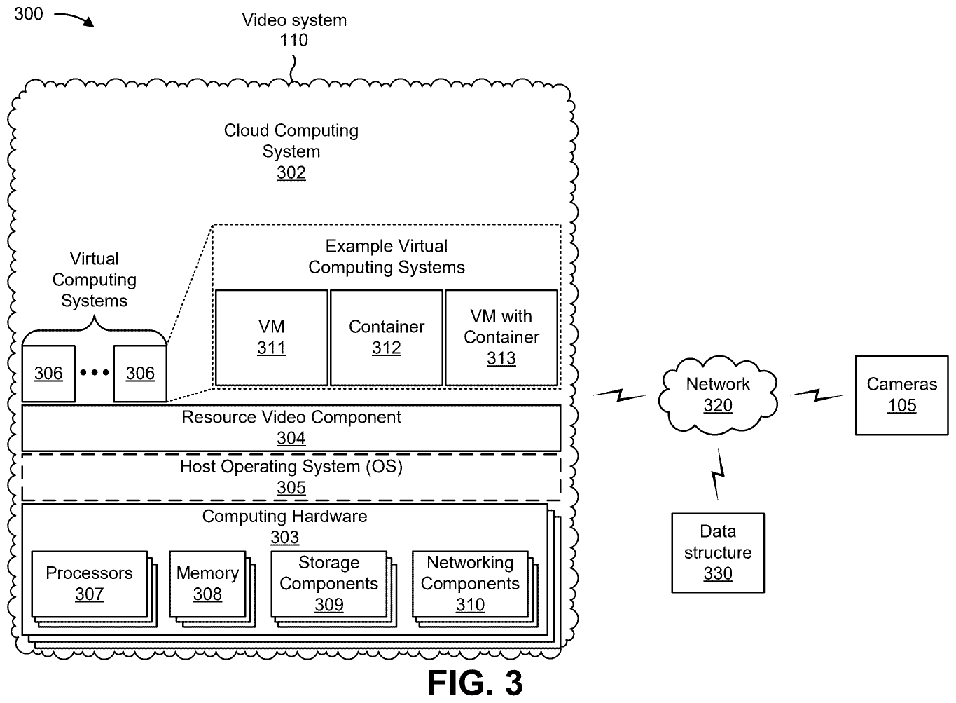

FIG. 3 is a diagram of an example environment 300 in which systems and/or methods described herein may be implemented. As shown in FIG. 3, the environment 300 may include the video system 110, which may include one or more elements of and/or may execute within a cloud computing system 302. The cloud computing system 302 may include one or more elements 303-313, as described in more detail below. As further shown in FIG. 3, the environment 300 may include the camera 105, a network 320, and/or a data structure 330. Devices and/or elements of the environment 300 may interconnect via wired connections and/or wireless connections.

The camera 105 may include one or more devices capable of receiving, generating, storing, processing, providing, and/or routing information, as described elsewhere herein. The camera 105 may include a communication device and/or a computing device. For example, the camera 105 may include an optical instrument that captures videos (e.g., images and audio). The camera 105 may feed real-time video directly to a screen or a computing device for immediate observation, may record the captured video (e.g., images and audio) to a storage device for archiving or further processing, and/or the like. In some implementations, the camera 105 may include a dashcam of a vehicle, a forward facing camera of a vehicle, a driver facing camera of a vehicle, a side camera of a vehicle, a rear camera of a vehicle, and/or the like.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

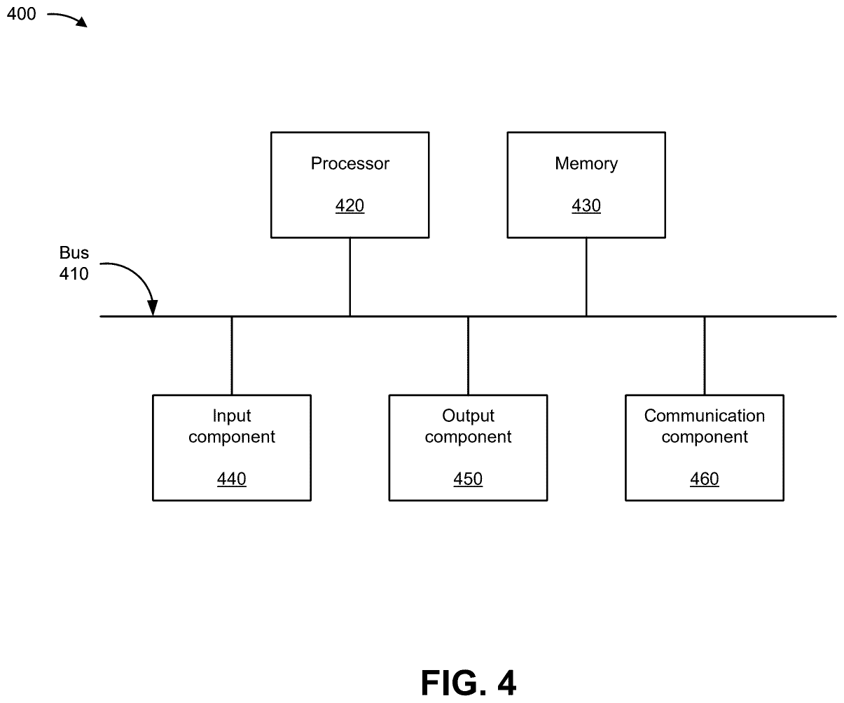

Although the video system 110 may include one or more elements 303-313 of the cloud computing system 302, may execute within the cloud computing system 302, and/or may be hosted within the cloud computing system 302, in some implementations, the video system 110 may not be cloud-based (e.g., may be implemented outside of a cloud computing system) or may be partially cloud-based. For example, the video system 110 may include one or more devices that are not part of the cloud computing system 302, such as a device 400 of FIG. 4, which may include a standalone server or another type of computing device. The video system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the camera 105, the video system 110, and/or the data structure 330. In some implementations, the camera 105, the video system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

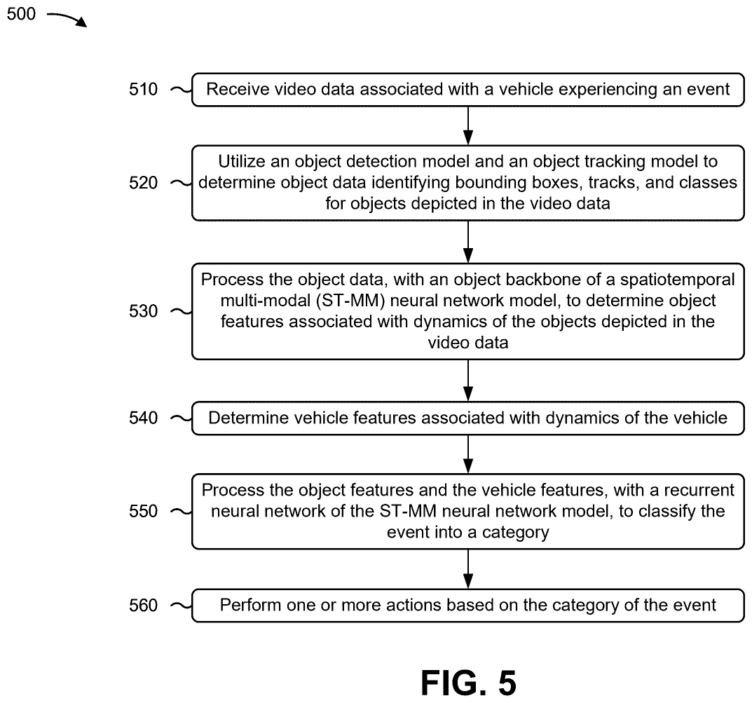

FIG. 5 depicts a flowchart of an example process 500 for utilizing a multi-modal neural architecture for detection and classification of driving events. In some implementations, one or more process blocks of FIG. 5 may be performed by a device (e.g., the video system 110). In some implementations, one or more process blocks of FIG. 5 may be performed by another device or a group of devices separate from or including the device, such as a control system of the vehicle, a camera (e.g., one of the cameras 105), and/or the like. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving video data associated with a vehicle experiencing an event (block 510). For example, the device may receive video data associated with a vehicle experiencing an event, as described above.

As further shown in FIG. 5, process 500 may include utilizing an object detection model and an object tracking model to determine object data identifying bounding boxes, tracks, and classes for objects depicted in the video data (block 520). For example, the device may utilize an object detection model and an object tracking model to determine object data identifying bounding boxes, tracks, and classes for objects depicted in the video data, as described above. In some implementations, utilizing the object detection model and the object tracking model to determine the object data includes extracting a track for each of the objects depicted in the video data to establish spatiotemporal coherence in the video data.

As further shown in FIG. 5, process 500 may include processing the object data, with an object backbone of an ST-MM neural network model, to determine object features associated with dynamics of the objects depicted in the video data (block 530). For example, the device may process the object data, with an object backbone of an ST-MM neural network model, to determine object features associated with dynamics of the objects depicted in the video data, as described above. In some implementations, processing the object data, with the object backbone of the ST-MM neural network model, to determine the object features includes utilizing one-dimensional convolutional layers to process the tracks independently for each of the objects depicted in the video data. In some implementations, processing the object data, with the object backbone of the ST-MM neural network model, to determine the object features includes applying non-maximal suppression model to the objects to mitigate incorrect object categorizations in the video data.

As further shown in FIG. 5, process 500 may include determining vehicle features associated with dynamics of the vehicle (block 540). For example, the device may determine vehicle features associated with dynamics of the vehicle, as described above. In some implementations, determining the vehicle features associated with the dynamics of the vehicle includes processing the video data, with an ego-motion module of the ST-MM neural network model, to determine the vehicle features associated with the dynamics of the vehicle.

As further shown in FIG. 5, process 500 may include processing the object features and the vehicle features, with a recurrent neural network of the ST-MM neural network model, to classify the event into a category (block 550). For example, the device may process the object features and the vehicle features, with a recurrent neural network of the ST-MM neural network model, to classify the event into a category, as described above. In some implementations, processing the object features and the vehicle features, with the recurrent neural network of the ST-MM neural network model, to classify the event into the category includes utilizing the recurrent neural network of the ST-MM neural network model to merge the object features and the vehicle features and to extract spatiotemporal information, and classifying the event into the category based on the spatiotemporal information, the object features, and the vehicle features. In some implementations, the category includes one of a normal event, a near-crash event, or a crash event.

As further shown in FIG. 5, process 500 may include performing one or more actions based on the category of the event (block 560). For example, the device may perform one or more actions based on the category of the event, as described above. In some implementations, performing the one or more actions includes one or more of providing the category of the event for display with the video data, providing a report identifying the category of the event to a driver of the vehicle, or scheduling a driver of the vehicle for driver education training based on the category of the event. In some implementations, performing the one or more actions includes one or more of providing an alert identifying the category of the event to a fleet manager of the vehicle, or retraining the ST-MM neural network model based on the category of the event.

In some implementations, process 500 includes receiving training data identifying crash events, near-crash events, and normal events, and training the ST-MM neural network model with the training data. In some implementations, process 500 includes receiving sensor data identifying a speed, an acceleration, and an angular velocity of the vehicle, and determining the vehicle features associated with the dynamics of the vehicle includes processing the sensor data, with a sensor backbone of the ST-MM neural network model, to determine the vehicle features associated with the dynamics of the vehicle. In some implementations, process 500 includes modifying the sensor data identifying the speed of the vehicle to match a frequency of the sensor data identifying the acceleration and the angular velocity of the vehicle. In some implementations, process 500 includes synchronizing the sensor data through convolutional encoding to align the sensor data with the video data.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, video data associated with a vehicle experiencing an event;
utilizing, by the device, an object detection model and an object tracking model to determine object data identifying bounding boxes, tracks, and classes for objects depicted in the video data;
processing, by the device, the object data, with an object backbone of a spatiotemporal multi-modal (ST-MM) neural network model, to determine object features associated with dynamics of the objects depicted in the video data;
determining, by the device, vehicle features associated with dynamics of the vehicle;
processing, by the device, the object features and the vehicle features, with a recurrent neural network of the ST-MM neural network model, to classify the event into a category; and
performing, by the device, one or more actions based on the category of the event.

2. The method of claim 1, further comprising:
receiving training data identifying crash events, near-crash events, and normal events; and
training the ST-MM neural network model with the training data.

3. The method of claim 1, further comprising:
receiving sensor data identifying a speed, an acceleration, and an angular velocity of the vehicle,
wherein determining the vehicle features associated with the dynamics of the vehicle comprises:
processing the sensor data, with a sensor backbone of the ST-MM neural network model, to determine the vehicle features associated with the dynamics of the vehicle.

4. The method of claim 3, further comprising:
modifying the sensor data identifying the speed of the vehicle to match a frequency of the sensor data identifying the acceleration and the angular velocity of the vehicle.

5. The method of claim 3, further comprising:
synchronizing the sensor data through convolutional encoding to align the sensor data with the video data.

6. The method of claim 1, wherein determining the vehicle features associated with the dynamics of the vehicle comprises:
processing the video data, with an ego-motion module of the ST-MM neural network model, to determine the vehicle features associated with the dynamics of the vehicle.

7. The method of claim 1, wherein performing the one or more actions comprises one or more of:
providing the category of the event for display with the video data;
providing a report identifying the category of the event to a driver of the vehicle; or
scheduling a driver of the vehicle for driver education training based on the category of the event.

8. A device, comprising:
one or more processors configured to:
receive video data associated with a vehicle experiencing an event;
utilize an object detection model and an object tracking model to determine object data identifying bounding boxes, tracks, and classes for objects depicted in the video data;
process the object data, with an object backbone of a spatiotemporal multi-modal (ST-MM) neural network model, to determine object features associated with dynamics of the objects depicted in the video data,
wherein the ST-MM neural network model is trained with training data identifying crash events, near-crash events, and normal events;
determine vehicle features associated with dynamics of the vehicle;
process the object features and the vehicle features, with a recurrent neural network of the ST-MM neural network model, to classify the event into a category; and
perform one or more actions based on the category of the event.

9. The device of claim 8, wherein the one or more processors, to perform the one or more actions, are configured to:
provide an alert identifying the category of the event to a fleet manager of the vehicle; or
retrain the ST-MM neural network model based on the category of the event.

10. The device of claim 8, wherein the one or more processors, to utilize the object detection model and the object tracking model to determine the object data, are configured to:
extract a track for each of the objects depicted in the video data to establish spatiotemporal coherence in the video data.

11. The device of claim 8, wherein the one or more processors, to process the object data, with the object backbone of the ST-MM neural network model, to determine the object features, are configured to:
utilize one-dimensional convolutional layers to process the tracks independently for each of the objects depicted in the video data.

12. The device of claim 8, wherein the one or more processors, to process the object data, with the object backbone of the ST-MM neural network model, to determine the object features, are configured to:
apply non-maximal suppression model to the objects to mitigate incorrect object categorizations in the video data.

13. The device of claim 8, wherein the one or more processors, to process the object features and the vehicle features, with the recurrent neural network of the ST-MM neural network model, to classify the event into the category, are configured to:
utilize the recurrent neural network of the ST-MM neural network model to merge the object features and the vehicle features and to extract spatiotemporal information; and
classify the event into the category based on the spatiotemporal information, the object features, and the vehicle features.

14. The device of claim 8, wherein the category includes one of a normal event, a near-crash event, or a crash event.

15. A non-transitory computer-readable medium storing a set of instructions, the set of instructions comprising:
one or more instructions that, when executed by one or more processors of a device, cause the device to:
receive video data associated with a vehicle experiencing an event;
utilize an object detection model and an object tracking model to determine object data identifying bounding boxes, tracks, and classes for objects depicted in the video data;
process the object data, with an object backbone of a spatiotemporal multi-modal (ST-MM) neural network model, to determine object features associated with dynamics of the objects depicted in the video data;
determine vehicle features associated with dynamics of the vehicle;
process the object features and the vehicle features, with a recurrent neural network of the ST-MM neural network model, to classify the event into a category,
wherein the category includes one of a normal event, a near-crash event, or a crash event; and
perform one or more actions based on the category of the event.

16. The non-transitory computer-readable medium of claim 15, wherein the one or more instructions further cause the device to:
receive sensor data identifying a speed, an acceleration, and an angular velocity of the vehicle,
wherein the one or more instructions, that cause the device to determine the vehicle features associated with the dynamics of the vehicle, cause the device to:
process the sensor data, with a sensor backbone of the ST-MM neural network model, to determine the vehicle features associated with the dynamics of the vehicle.

17. The non-transitory computer-readable medium of claim 16, wherein the one or more instructions further cause the device to one or more of:
modify the sensor data identifying the speed of the vehicle to match a frequency of the sensor data identifying the acceleration and the angular velocity of the vehicle; or
synchronize the sensor data through convolutional encoding to align the sensor data with the video data.

18. The non-transitory computer-readable medium of claim 15, wherein the one or more instructions, that cause the device to determine the vehicle features associated with the dynamics of the vehicle, cause the device to:
process the video data, with an ego-motion module of the ST-MM neural network model, to determine the vehicle features associated with the dynamics of the vehicle.

19. The non-transitory computer-readable medium of claim 15, wherein the one or more instructions, that cause the device to perform the one or more actions, cause the device to one or more of:
provide the category of the event for display with the video data;
provide a report identifying the category of the event to a driver of the vehicle;
schedule a driver of the vehicle for driver education training based on the category of the event;
provide an alert identifying the category of the event to a fleet manager of the vehicle; or
retrain the ST-MM neural network model based on the category of the event.

20. The non-transitory computer-readable medium of claim 15, wherein the one or more instructions, that cause the device to utilize the object detection model and the object tracking model to determine the object data, cause the device to one or more of:
extract a track for each of the objects depicted in the video data to establish spatiotemporal coherence in the video data; or
utilize one-dimensional convolutional layers to process the tracks independently for each of the objects depicted in the video data.
